(19) United States
(12) Patent Application Publication
(10) Pub. No.: US 2014/0298715 A1
(43) Pub. Date: Oct. 9, 2014

(54) GRAVITATIONAL SETTLING TANK AND ASH-FREE COAL PRODUCTION METHOD USING THE SAME

(71) Applicant: Kabuski Kaisha Kobe Seiko Sho (Kobe Steel, Ltd), Hyogo (JP)

(72) Inventors: Koji Sakai, Hyogo (JP); Noriyuki Okuyama, Hyogo (JP)

(73) Assignee: KABUSHIKI KAISHA KOBE SEIKO SHO (KOBE STEEL, LTD.), Hyogo (JP)

(21) Appl. No.: 14/357,634

(22) PCT Filed: Dec. 17, 2012
(86) PCT No.: PCT/JP2012/082603

§ 371 Date: May 12, 2014

(30) Foreign Application Priority Data
Dec. 28, 2011 (JP) 2011-288712

(51) Int. Cl. C10L 5/04; B01D 21/32

(52) U.S. Cl. CPC C10L 5/04; B01D 21/32
USPC 44/627; 210/86

(57) ABSTRACT

Provided is a gravitational settling tank capable of detecting a boundary surface of a solids-enriched fluid. A pressure vessel 11 is provided with a multipoint temperature sensor 18 including two or more thermocouples 17 to measure the temperature of an internal fluid in the pressure vessel 11. Two or more temperature measuring junctions 17a of the thermocouples 17 are arranged in the pressure vessel 11 so as to be immersed in the internal fluid and positioned at different heights from one another. The boundary surface of the solids-enriched fluid is detected based on the temperature distribution of the internal fluid in the pressure vessel 11, where the temperature distribution is determined with the multipoint temperature sensor 18.

### TECHNICAL FIELD

The present invention relates to a gravitational settling tank for the production of an ash-free coal by removing ash from coal; and an ash-free coal production method using the gravitational settling tank.

### BACKGROUND ART

Patent literature (PTL) 1 discloses an ash-free coal production method. The production method produces an ash-free coal by mixing general coal with caking coal (coking coal) to give material coat mixing the material coal with a solvent to give a slurry; heating the resulting slurry to extract a solvent-soluble coal component; separating the slurry including the extracted coal component into a supernatant liquid and a solids-enriched fluid by a gravitational settling technique, where the supernatant liquid contains the solvent-soluble coal component, and the solids-enriched fluid contains a solvent-insoluble coal component; and removing the solvent from the separated supernatant liquid to give the ash-free coal.

### CITATION LIST

### Patent Literature

PTL 1: Japanese Unexamined Patent Application Publication (JP-A) No. 2009-227718

### SUMMARY OF INVENTION

### Technical Problem

In the technique disclosed in PTL1, the sedimentation (settling) step of separating the supernatant liquid from the solids-enriched fluid is performed using a high-temperature high-pressure vessel. To prevent contamination of the solids-enriched fluid into the supernatant liquid to be discharged from the top of the high-temperature high-pressure vessel, the position (height) of the boundary surface of the solids-enriched fluid should be grasped, and the boundary surface, if being excessively high, should be lowered. Likewise, to prevent contamination of the supernatant liquid into the solids-enriched fluid to be discharged from the bottom of the high-temperature high-pressure vessel, the position of the boundary surface of the solids-enriched fluid should be gasped, and the boundary surface, if being excessively low, should be raised. However, direct detection of the boundary surface position of the solids-enriched fluid is impossible because direct observation of inside of the high-temperature high-pressure vessel is impossible.

An object of the present invention is to provide a gravitational settling tank capable of detecting the boundary surface of the solids-enriched fluid. Another object of the present invention is to provide an ash-free coal production method using the gravitational settling tank.

### Solution to Problem

The present invention provides a gravitational settling tank which includes: a pressure vessel that settles solids contained in a slurry to separate the slurry into a solids-enriched fluid and a supernatant liquid, where the slurry is a mixture of coal and a solvent; and a supply pipe that feeds the slurry to the pressure vessel, in which: the pressure vessel includes a temperature measurer inside thereof, where the temperature measurer measures a temperature of an internal fluid in the pressure vessel; the temperature measurer includes two or more temperature detecting units arranged in the pressure vessel so as to be immersed in the internal fluid and positioned at different heights from one another; and a boundary surface of the solids-enriched fluid is detected based on a temperature distribution of the internal fluid in the pressure vessel, where the temperature distribution is determined with the temperature measurer.

### Advantageous Effects of Invention

The gravitational settling tank and the ash-free coal production method using the same according to embodiments of the present invention can detect the boundary surface of the solids-enriched fluid.

### BRIEF DESCRIPTION OF DRAWINGS

FIG. 1 is a schematic view of production equipment.

FIG. 2 is a schematic view of a gravitational settling tank.

FIG. 3 is a graph illustrating results of solids concentration measurements.

### DESCRIPTION OF EMBODIMENTS

A preferred embodiment of the present invention will be illustrated with reference to the attached drawings.

### Structure of Production Apparatus

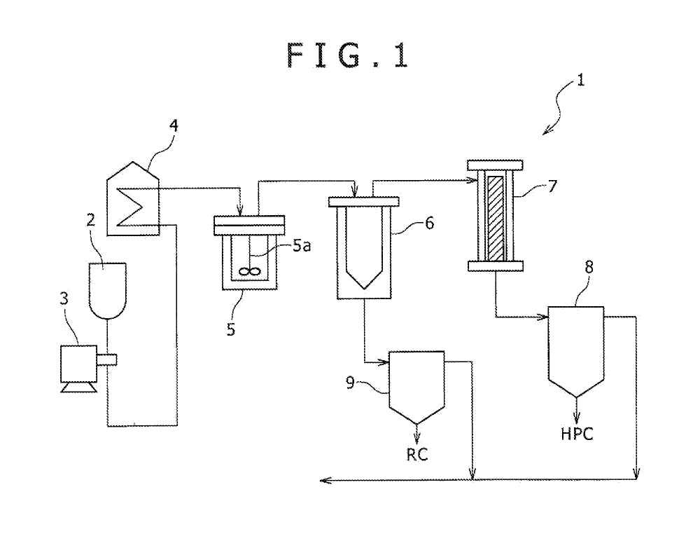

An ash-free coal production method according to the present embodiment includes a slurry preparation step, an extraction step, a separation step, and an ash-free coal obtaining step, and may further include a residue coal obtaining step when desired. The ash-free coal production method according to the present embodiment will be illustrated in detail with reference to FIG. 1. FIG. 1 is a schematic view illustrating exemplary ash-free coal production equipment 1 used to perform the ash-free coal production method according to the present embodiment.

Slurry Preparation Step

The slurry preparation step is the step of mixing coal with a solvent to prepare a slurry and is performed in a slurry preparation tank 2.

The coal to be used as a material is not limited and may be any of bituminous coal having a high extraction rate (ash-free coal recovery rate); and more inexpensive low-quality coal (e.g., subbituminous coal or lignite).

The solvent is not limited, as long as capable of dissolving coal, therein, but is preferably a coal-derived oil. The “coal-derived oil” refers to an oil obtained from coal. Of such coal-derived oils, a non-hydrogen-donor solvent mainly containing bicyclic aromatic compounds is typically preferred. The non-hydrogen-donor solvent is a coal derivative that is purified mainly from a carbonization product of the coal, mainly contains bicyclic aromatic compounds, and serves as a solvent. The non-hydrogen-donor solvent is stable even under heating and has satisfactory affinity for the coal. The non-hydrogen-donor solvent thereby has a high rate of a soluble component (herein a “coal component”) to be extracted into the solvent, and acts as a solvent easily recoverable by a process such as distillation. The rate of the coal component to be extracted is hereinafter also referred to as “extraction rate”.

The non-hydrogen-donor solvent contains principal components including bicyclic aromatic compounds such as naphthalene, methylnaphthalene dimethylnaphthalene, and trimethylnaphthalene. The non-hydrogen-donor solvent may further contain, as other components, naphthalenes, anthracenes, and fluorenes each having an aliphatic side chain; and alkylbenzenes corresponding to them, except with biphenyl and/or a long-chain aliphatic side chain.

The above description has been made by taking a non-hydrogen-donor compound as an example of the solvent to be used. Certainly, a hydrogen-donor compound (including a coal-derived liquid) typified by tetralin can also be used as the solvent. The hydrogen-donor solvent, when used, contributes to a higher yield of the ash-free coal. As used herein the term “yield of the ash-free coal” refers to the ratio of the mass of the produced ash-free real to the mass of the material coal.

Though not critical, the solvent has a boiling point of typically preferably from 180° C. to 300° C., and particularly preferably from 240° C. to 280° C. The boiling point range is preferred from the viewpoints of reducing the pressure in the extraction step and the separation step and of providing a satisfactory extraction rate in the extraction step and a satisfactory solvent recovery rate in the ash-free coal obtaining step.

The ratio of the coal to the solvent is typically from 10 to 50 percent by weight, and more preferably from 20 to 35 percent by weight, on a dry coal basis.

Extraction Step

The extraction step is the step of heating the slurry obtained from the slurry preparation step to extract a solvent-soluble coal component (solvent-soluble component) and is performed in an extractor 5. The slurry prepared in the slurry preparation tank 2 is once fed to a preheater 4 with a pump 3 and is heated up to a predetermined temperature. The preheated slurry is fed to the extractor 5 and is extracted with heating to be held at the predetermined temperature while being stirred with a stirrer 5a arranged in the extractor 5. The slurry may be fed to the extractor 5 without passing through the preheater 4.

The extraction of a solvent-soluble coal component by heating a slurry as a mixture of coal and a solvent may be performed by mixing the coal with a solvent having high dissolving power (solvency) with respect to the coal to give a slurry; and heating the slurry to extract an organic component in the coat. The solvent having high dissolving power to be used herein is often the aromatic solvent (hydrogen-donor or non-hydrogen-donor solvent).

As used herein the term “solvent-soluble component” refers to a coal component soluble in the solvent and is mainly derived from an organic component in the coal, which organic component has a relatively low molecular weight with an undeveloped crosslinked structure.

A slurry heating temperature in the extraction step is not critical, as long as the solvent-soluble component can be dissolved, but is typically from 300° C. to 420° C., and more preferably from 360° C. to 400° C. The range is preferred for sufficient extraction of the solvent-soluble component. A heating time (extraction time) is also not critical, but is typically from 10 to 60 minutes for sufficient dissolution and better extraction rate. The term “heating time” refers to a total sum of a heating lime in the preheater 4 and a heating time in the extractor 5.

The extraction step is performed in the presence of an inert gas such as nitrogen gas. An inside pressure of the extractor 5 is preferably from 1.0 to 2.0 MPa, while the pressure may vary depending on the extraction temperature and the vapor pressure of the solvent to be used. If the inside pressure of the extractor 5 is lower than the solvent vapor pressure, the solvent fails to be trapped in a liquid phase because of its volatilization, and this impedes extraction. Trapping of the solvent in the liquid phase requires a pressure higher than the solvent vapor pressure. In contrast, an excessively high inside pressure may cause higher facilities cost and operation cost, thus being uneconomical.

Separation Step

The separation step is the step of separating the slurry obtained from the extraction step into a supernatant liquid and a solids-enriched fluid using a gravitational settling tank 6, which gravitational settling tank 6 performs the separation by the gravitational settling technique. The supernatant liquid is a solution fraction of the solvent-soluble component dissolved therein; whereas the solids-enriched fluid is a slurry fraction containing a solvent-insoluble coal component (solvent-insoluble component). Hereinafter a fluid including both the supernatant liquid and the solids-enriched fluid is referred to as an “internal fluid”. The supernatant liquid in an upper part of the gravitational settling tank 6 is discharged, where necessary via a filter unit 7, to a solvent separator 8; whereas the solids-enriched fluid settled in a lower part of the tank is discharged to a solvent separator 9.

The “solvent-insoluble component” herein refers to a coal component that remains without being dissolved in a solvent even after dissolution and extraction of coal with the solvent, where the coal component is exemplified by ash and coal containing the ash (i.e., ash-rich coal or residue coal). The solvent-insoluble component is mainly derived from an inorganic component contained in the coal or from an organic component that is not extracted with the solvent and has a relatively high molecular weight with a developed crosslinked structure.

The gravitational settling technique is the technique of precipitating (settling) and separating a solvent-insoluble component using gravity while holding the slurry in the tank. Continuous separation treatment is possible by continuously discharging the supernatant liquid and the solids-enriched fluid from the top (overhead) and the bottom, respectively, while continuously feeding the slurry into the tank.

The inside of the gravitational settling tank 6 is preferably held in temperature (heated) and/or pressurized so as to prevent reprecipitation of the solvent-soluble component which has been dissolved out from the material coal. The heating herein is performed at a temperature of typically from 300° C. to 420° C., and the pressure inside the tank is typically from 1.0 to 3.0 MPa.

### Structure of Gravitational Settling Tank

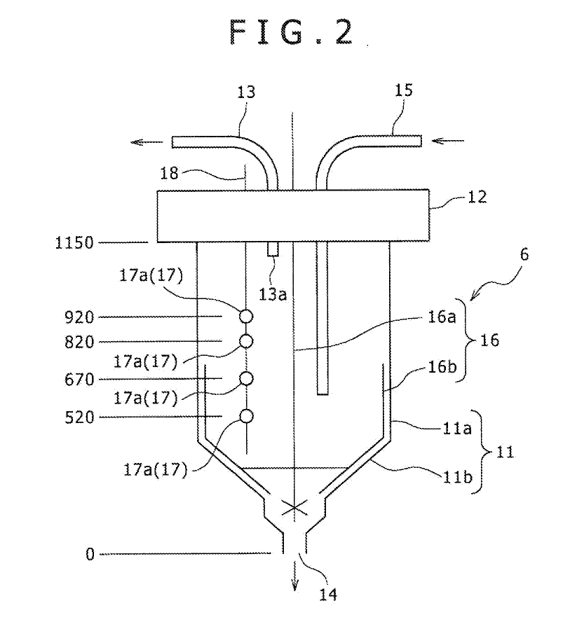

Next, the gravitational settling tank 6 according to an embodiment of the present invention will be illustrated below. With reference to FIG. 2, the gravitational settling tank 6 typically includes a pressure vessel 11, a lid 12, a supernatant liquid discharge pipe 13, an outlet 14, a slurry supply pipe (supply pipe) 15, and a rake 16. Each of numerical values in FIG. 2 indicates a height (mm) from the basal plane of the pressure vessel 11.

Pressure Vessel

The pressure vessel 11 acts as a vessel for separating the slurry into a solids-enriched fluid and a supernatant liquid and includes a cylindrical body 11a and a bottom 11b. The bottom 11b is arranged at a lower end of the body 11a and is tapered downward. A lid 12 is provided at an upper end of the body 11a so as to seal the upper end hermetically. The pressure vessel 11 is not limited to the cylindrical shape but may have another shape.

Supernatant Liquid Discharge Pipe

The supernatant liquid discharge pipe 13 is arranged to discharge a supernatant liquid from the gravitational settling tank 6, which supernatant liquid is accumulated in the upper portion of the pressure vessel 11. The supernatant liquid discharge pipe 13 penetrates the lid 12 and extends to the upper part of the body 11a. An outlet 13a is arranged at an end of the supernatant liquid discharge pipe 13, from which the supernatant liquid is discharged. The amount of the supernatant liquid to be discharged from the pressure vessel 11 via the supernatant liquid discharge pipe 13 is controlled by a control device (not show) such as a solenoid-controlled valve. The supernatant liquid discharge pipe 13 may be arranged so as to penetrate a side wall of the body 11a.

Outlet

The outlet 14 is arranged so as to discharge a solids-enriched fluid settling in the lower portion of the pressure, vessel 11 from the gravitational settling tank 6 and is located in the lowermost part of the bottom 11b. The amount of the solids-enriched fluid to be discharged from the pressure vessel 11 via the outlet 14 is controlled by a control device (not shown) such as a solenoid-controlled valve. The outlet 14 may be arranged to penetrate the side wall of the bottom 11b.

Slurry Supply Pipe

The slurry supply pipe 15 is arranged to feed the slurry into the pressure vessel 11, penetrates the lid 12, and extends to a central part (lower part of the body 11a) in the height direction of the pressure vessel 11. The slurry supply pipe 15 may be arranged to penetrate the side wall of the body 11a and to extend from the side wall into the pressure vessel 11.

Rake

The rake 16 is arranged to agitate the solids-enriched fluid settling in the lower part of the pressure vessel 11. The rake 16 has a rotating shaft 16a and two or more blades 16b. The rotating shaft 16a penetrates the lid 12 and is rotationally driven by a motor (not shown). The blades 16b are connected to the rotating shaft 16a and are arranged so as to scrape off the solids-enriched fluid attached to the inner wall of the bottom 11b.

Thermometer

The gravitational settling tank 6 further includes a rod-shaped multipoint temperature maser (thermometric device) 18 to measure the temperature of the internal fluid in the pressure vessel 11. The multipoint temperature sensor 18 includes two or more thermocouples (temperature measurer) 17 that are aligned vertically in the pressure vessel 11. The multipoint temperature sensor 18 can be fixed typically to a flange of the lid 12. Two or more temperature measuring junctions (temperature detecting units) 17a of the thermocouples 17 are arranged in the pressure vessel 11 so as to be immersed in the internal fluid and positioned at different heights from one another. Thus, the temperature measuring junctions 17a are aligned vertically in the pressure vessel 11. The temperature measuring junctions 17a are arranged at heights of 520 mm, 670 mm, 820 mm, and 920 mm from the basal plane of the pressure vessel 11 in the present embodiment, but the arrangement is not limited thereto. In FIG. 2, four temperature measuring junctions 17a are illustrated. However, the number of the temperature measuring junctions 17a (i.e., the number of the thermocouples 17) is not limited thereto and may be 3 or less, or 5 or more. Each of the temperature measuring junctions 17a allows a voltage to occur at a level corresponding to the temperature of the solids-enriched fluid or supernatant liquid in the pressure vessel 11. The temperature of the internal fluid at the height where the each temperature measuring junction 17a is arranged can be measured by measuring the voltage. This enables the measurement of a height-direction temperature distribution of the internal fluid in the pressure vessel 11.

The multipoint temperature sensor 18 herein is preferably arranged at a horizontal central part of the pressure vessel 11 (in the vicinity of the rotating shaft 16a of the rake 16). This is because convection less affects the temperature to be measured at the central part of the pressure vessel 11; whereas the external air with a temperature lower than that in the pressure vessel 11 affects the temperature in the vicinity of the side wall of the pressure vessel 11. The multipoint temperature sensor 18 is preferably arranged at a position away from the slurry supply pipe 15 so as not to be in direct contact with a high-temperature slurry fed from the slurry supply pipe 15.

Only one multipoint temperature sensor 18 is illustrated in FIG. 2. However, in a preferred embodiment, two or more multipoint temperature sensors 18 are arranged in the pressure vessel 11. In this embodiment, the temperature measuring junctions 17a are preferably aligned not only vertically but also horizontally by arranging the temperature measuring junctions 17a of the thermocouples 17 respectively constituting the multipoint temperature sensors 18 to be aligned in height among the multipoint temperature sensors 18. This provides two or more temperature measuring junctions 17a contributing to the detection of temperature(s) at the same height and enables precise detection of the temperature at that height. In a particularly preferred embodiment, three or more temperature measuring junctions 17a are provided to measure temperatures at the same height. In this embodiment, a temperature measuring junction 17a that detects a temperature different from a temperature detected by the other majority of the temperature measuring junctions 17a can be regarded as suffering a breakdown.

The gravitational settling tank according to the present embodiment employs a multipoint temperature sensor 18 including two or more thermocouples 17. In another embodiment, the tank may employ, instead of the multipoint temperature sensor 18, a bundle of two or more thermocouples 17 in which temperature measuring junctions 17a are arranged at different heights. In this embodiment, the bundle of two or more thermocouples 17 acts as a thermometric device. In another embodiment, two or more thermocouples 17 are arranged at different heights to penetrate the side wall of the body 11a of the pressure vessel 11 and extends from the side wall into the pressure vessel 11. The gravitational settling tank according to this embodiment can measure the height-direction temperature distribution (vertical distribution) of the internal fluid in the pressure vessel 11.

The solids-enriched fluid has a temperature higher than that of the supernatant liquid in the pressure vessel 11. This enables the detection of the boundary surface of the solids-enriched fluid based on the difference in temperature between the solids-enriched fluid and the supernatant liquid. Specifically, a height at which the temperature difference occurs, namely, the boundary surface of the solids-enriched fluid, can be detected by measuring the height-direction temperature distribution of the internal fluid in the pressure vessel 11 with the two or more thermocouples 17 having temperature measuring junctions 17a arranged at different heights.

The temperature measuring junctions 17a, as being aligned vertically, can measure the height-direction temperature distribution of the internal fluid in the pressure vessel 11 at the same horizontal level. This allows the temperature distribution measurement to resist influence of the horizontal variation in temperature.

When two or more temperature measuring junctions 17a are aligned not only vertically but also horizontally as in the preferred embodiment, two or more temperature measuring junctions 17a contribute to temperature detection at the same height, and this enables precise temperature detection at that height. In a particularly preferred embodiment, three or more temperature measuring junctions 17a are provided to measure temperatures at the same height. In this embodiment, a temperature measuring junction 17a that detects a temperature different from a temperature detected by the other majority of the temperature measuring junctions 17a can be regarded as suffering a breakdown.

The multipoint temperature sensor 18 including two or more thermocouples 17, when employed, can be easily arranged in the pressure vessel 11 and enables inexpensive and wide-range temperature measurement.

In an embodiment, a control device (not shown) controls at least one of the amount of the supernatant liquid to be discharged from the pressure vessel 11 via the supernatant liquid discharge pipe 13 and the amount of the solids-enriched fluid to be discharged from the pressure vessel 11 via the outlet 14. This allows the boundary surface of the solids-enriched fluid to be lowered or raised, which boundary surface has been detected with the thermocouples 17. Thus, when the boundary surface of the solids-enriched fluid is present at an excessively high level (height), the supernatant liquid discharged from the pressure vessel ii can be prevented from containing the solids-enriched fluid by lowering the boundary surface of the solids-enriched fluid. The lowering may be performed typically by controlling the discharge amounts of the fluids so as to decrease the amount of the supernatant liquid to be discharged from the pressure vessel 11 via the supernatant liquid discharge pipe 13 and to increase the amount of the solids-enriched fluid to be discharged from the pressure vessel 11 via the outlet 14. In another embodiment, the discharge amount of the supernatant liquid may possibly be unchanged or increased upon lowering of the boundary surface of the solids-enriched fluid. In contrast, when the boundary surface of the solids-enriched fluid is present at an excessively low level, the solids-enriched fluid to be discharged from the pressure vessel 11 can be prevented from containing the supernatant liquid by raising the boundary surface of the solids-enriched fluid. The raising maybe achieved typically by controlling the discharge amounts so as to decrease the amount of the solids-enriched fluid to be discharged from the pressure vessel 11 via the outlet 14 and to increase the amount of the supernatant liquid to be discharged from the pressure vessel 11 via the supernatant liquid discharge pipe 13. In another embodiment, the discharge amount of the solids-enriched fluid may be possibly unchanged or increased upon raising of the boundary sulfate of the solids-enriched fluid.

Ash-Free Coal Obtaining Step

With reference to FIG. 1 again, the ash-free coal obtaining step is the step of separating or removing the solvent from the solution by evaporative separation to yield an ash-free coal, where the solution has been separated in the separation step. The step performed in a solvent separator 8.

As used herein the term “evaporative separation” refers to a separation process exemplified by regular distillation processes such as thin-film distillation and flash vaporization; and evaporation processes such as spray drying. The separated and recovered solvent can be recycled to and reused in the slum preparation tank 2. The separation and recovery of the solvent allows the solution to give an ash-free coal (hypercoal; HPC) containing substantially no ash. The ash-free coal may have an ash content of 5 percent by weight or less, and, preferably 3 percent by weight or less.

The ash-free mal contains little ash and substantially no moisture and exhibits a heating value (heat output) higher than that of the material coal. In addition, the ash-free coal has significantly better thermoplasticity. Thus, even a material opal having no thermoplasticity can give ash-free coal having satisfactory thermoplasticity. The thermoplasticity is particularly important when the ash-free coal is used as coal for coke making, which coke is in turn for iron making. The ash-free coal is therefore usable typically as a coal blend for coke making.

Residue Coal Obtaining Step

The residue coal obtaining step is the step of obtaining residue coal by flashing off the solvent from the solids-enriched, which solids-enriched fluid is separated in the separation step. The step is performed in a solvent separator 9.

The flashing off is a separation technique including regular distillation techniques; and evaporation techniques such as spray drying. The separated and recovered solvent can be recycled to and reused in the slurry preparation tank 2. The separation and recovery of the solvent allows the solids-enriched fluid to give residue coal (RC) containing concentrated solvent-insoluble components such as ash. While containing ash, the residue coal contains substantially no moisture and has a sufficient heating value. Although not exhibiting thermoplasticity, the residue coal, when used in a coal blend, does not adversely affect the thermoplasticity of other coals contained in the coal blend, because oxygen-containing functional groups have been eliminated therefrom. The residue coal may therefore be usable as part of a coal blend for coke making in the same way as common non- or slightly-caking coal. The residue coal may also be used as a fuel for various applications instead of being used as the coal for coke making. The residue coal may be discarded without recovery.

Solids Concentration Measurement

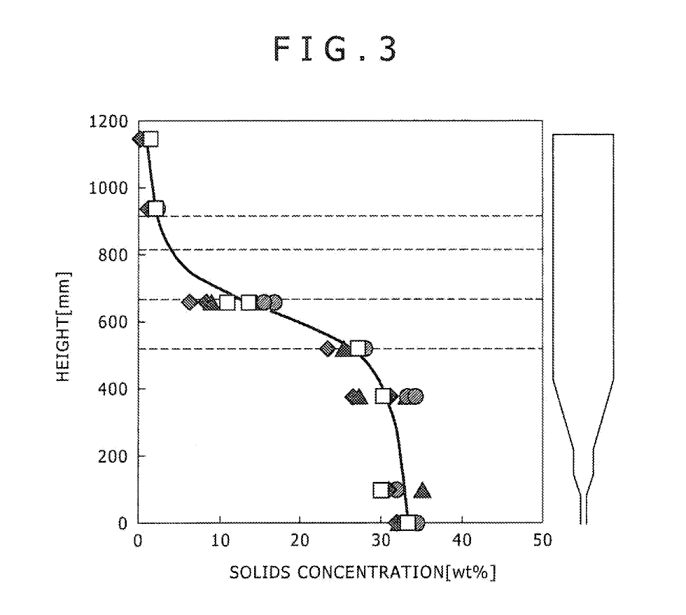

Next, solid-liquid separation was performed in the gravitational settling tank 6 illustrated in FIG. 2, and the concentration of solids therein was measured. Specifically, a slurry was prepared so as to have a coal concentration of 20 percent by weight, fed to the extractor 5 (see FIG. 1) at a flow rate of 24 kg/h, and subjected to extraction at 400° C. and 2.0 MPa for 20 min. The resulting slurry was fed to the gravitational settling tank 6 at a flow rate of 24 kg/h and separated into a solids-enriched fluid and a supernatant liquid. The solids-enriched fluid was discharged from the outlet 14 of the gravitational settling tank 6 at a flow rate of 5.7 kg/h. The remainder of the slurry was discharged from the supernatant liquid discharge pipe 13 of the gravitational settling tank 6 at a flow rate of 18.3 kg/h. The slurry fed to the gravitational settling tank 6 contained solids in a concentration of 7.0 percent by weight. An internal fluid was sampled from inside of the gravitational settling tank 6, and a solids concentration thereof was measured. In the gravitational settling tank 6, temperature measuring junctions 17a of thermocouples 17 were arranged at heights from the basal plane of 520 mm, 670 mm, 820 mm, and 920 mm. The temperatures of the internal fluid at the individual heights were measured. The results are indicated in FIG. 3.

The solids concentration was substantially constant and of about 30 percent by weight at heights of up to 500 mm; but abruptly decreased at heights of from 500 mm to 800 mm; and lowered down to 2 percent by weight or less at heights of 800 mm or higher. The measurement indicates that a solid boundary surface was present at a position (height) between 500 mm and 800 mm. In contrast, the temperature in the gravitational settling tank 6 lowered with an elevating height and was 350° C. at a height of 520 mm; 344° C. at a height of 670 mm; and 340° C. at heights of 820 mm and 920 mm. The measurement indicates that the temperature of the internal fluid was lowered in the boundary surface region where the solids concentration abruptly decreased; and that the temperature was high in a solids-enriched phase mainly containing the solids-enriched fluid, but was low in as clear phase mainly containing the supernatant liquid. Specifically, the measurement indicates that a difference in concentration, namely, a boundary surface was formed at a height where the difference in internal fluid temperature occurred. This demonstrates that the boundary surface of the solids-enriched fluid can be detected by examining the height at which the difference in internal fluid temperature occurs.

### Advantageous Effects

As is described above, the gravitational settling tank and the ash-free coal production method using the same according to embodiments of the present invention enable the detection of a height at which a temperature difference occurs, namely, the detection of the boundary surface of the solids-enriched fluid. This can be achieved by measuring the height-direction temperature distribution of the internal fluid in the pressure vessel 11 with the two or more thermocouples 17 including temperature measuring junctions 17a arranged at different heights from one another.

In an embodiment, the two or more temperature measuring junctions 17a are vertically aligned. This enables the measurement of the height-direction temperature distribution of the internal fluid in the pressure vessel 11 at the same horizontal positions (same levels) and allows the measurement to be less affected by horizontal variation in temperature.

In another embodiment, the two or more temperature measuring junction 17a are aligned not only vertically, but also horizontally. This allows two or more temperature measuring junctions 17a to contribute to temperature detection at the same height and enables precise temperature detection at that height. In a particularly preferred embodiment, three or more temperature measuring junctions 17a are provided to measure temperatures at the same height. In this embodiment, a temperature measuring junction 17a that detects a temperature different from a temperature detected by the other majority of the temperature measuring junctions 17a can be regarded as suffering a breakdown.

In another embodiment, a multipoint temperature sensor 18 including two or more thermocouples 17 is employed. The multipoint temperature sensor 18 can be easily arranged in the pressure vessel 11 and enables inexpensive and wide-range temperature measurement.

In another embodiment, at least one of the discharge amount of the solids-enriched fluid and the discharge amount of the supernatant liquid is controlled. This allows the boundary surface of the solids-enriched fluid to be lowered and raised, which boundary surface has been detected with the thermocouples 17. Thus, when the boundary surface of the solids-enriched fluid is present at an excessively high level (height), the supernatant liquid discharged from the pressure vessel 11 can be prevented from containing the solids-enriched fluid by lowering the boundary surface of the solids-enriched fluid. The lowering may be performed typically by controlling the discharge amounts of the fluids so as to decrease the amount of the supernatant liquid to be discharged from the pressure vessel 11 via the supernatant liquid discharge pipe 13 and to increase the amount of the solids-enriched fluid to be discharged from the pressure vessel 11 via the outlet 14. In contrast, when the boundary surface of the solids-enriched fluid is present at an excessively low level, the solids-enriched fluid to be discharged from the pressure vessel 11 can be prevented from containing the supernatant liquid by raising the boundary surface of the solids-enriched fluid. The raising may be achieved typically by controlling the discharge amounts so as to decrease the amount of the solids-enriched fluid to be discharged from the pressure vessel 11 via the outlet 14 and to increase the amount of the supernatant liquid to be discharged from the pressure vessel 11 via the supernatant liquid discharge pipe 13.

### Modifications of Present Invention

The present invention has been described with reference to certain embodiments Thereof. However, it should be understood that the embodiments are indicated for illustrative purpose only and are never intended to limit the scope of the invention and various modifications and variations are possible typically in specific construction. Operations and advantageous effects described in the embodiments of the present invention are only lists of most preferred operations and advantageous effects derived from the present invention. It should be noted that operations and advantageous effects of the present invention are not limited to those described in the embodiments of the present invention.

Typically, the temperature measurer employed is the thermocouples 17, but is not limited thereto, and may be any other temperature sensor.

### REFERENCE SIGNS LIST

1 production equipment

2 slurry preparation tank

3 pump

4 preheater

5 extractor

5a stirrer

6 gravitational settling tank

7 filter unit

8 solvent separator

9 solvent separator

11 pressure vessel

12 lid

13 supernatant liquid discharge pipe

14 outlet

15 slurry supply pipe (supply pipe)

16 rake

17 thermocouple (temperature measurer)

17a temperature measuring junction (temperature detecting unit)

18 multipoint temperature sensor (thermometric device)

1. A gravitational settling tank comprising:
a pressure vessel that settles solids contained in a slurry to separate the slurry into a solids-enriched fluid and a supernatant liquid, where the slurry is a mixture of coal and a solvent; and
a supply pipe that feeds the slurry to the pressure vessel,
wherein:
the pressure vessel comprises a temperature measurer inside of the pressure vessel, where the temperature measurer measures a temperature of an internal fluid in the pressure vessel;
the temperature measurer comprises two or more temperature detecting units arranged in the pressure vessel so as to be immersed in the internal fluid and positioned at different heights from one another; and
a boundary surface of the solids-enriched fluid is detected based on a temperature distribution of the internal fluid in the pressure vessel, where the temperature distribution is determined with the temperature measurer.

2. The gravitational settling tank according to claim 1, wherein the temperature detecting units are aligned vertically.

3. The gravitational settling tank according to claim 2, wherein the temperature detecting units are aligned not only vertically but also horizontally.

4. The gravitational settling tank according to claim 1, wherein the temperature measurer is a thermometric device comprising two or more thermocouples.

5. A method for producing an ash-free coal, the method comprising the steps of:
extracting a solvent-soluble coal component from coal by mixing the coal with a solvent to give a slurry and heating the slurry;
separating the slurry after the extraction of the coal component in the extraction step into a solids-enriched fluid and a supernatant liquid with the gravitational settling tank of claim 1; and
obtaining an ash-free coal by evaporatively separating the solvent from the supernatant liquid separated in the separation step.

6. The ash-free coal production method according to claim 5, wherein the separation step comprises the substeps of:
detecting a boundary surface of the solids-enriched fluid based on a temperature distribution in the pressure vessel, where the temperature distribution is determined with the temperature measurer; and
controlling at least one of a discharge amount of the solids-enriched fluid and a discharge amount of the supernatant liquid based on a height of the boundary surface as detected.
